(19) United States
(12) Patent Application Publication
(10) Pub. No.: US 2006/0002270 A1
(43) Pub. Date: Jan. 5, 2006

(54) System for applying combined laser light with extended output-power range

(75) Inventors: Atsuko Shimizu, Kanagawa-ken (JP); Manabu Mizumoto, Kanagawa-ken (JP); Takayuki Uemura, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/158,335

(22) Filed: Jun. 22, 2005

(30) Foreign Application Priority Data
Jun. 22, 2004 (JP) 183571/2004

(51) Int. Cl. G11B 7/00

(52) U.S. Cl. 369/59.1; 369/116; 369/53.1

(57) ABSTRACT

In a system for irradiating a recording medium with combined laser light which is generated by combining laser beams emitted from laser-light sources: a fraction of the laser-light sources are selected when a target value of the optical output power of the combined laser light determined in correspondence with the photosensitivity of the recording medium is smaller than a predetermined reference value. Then, each laser-light source in the fraction of the laser-light sources is driven with a driving current within a range from the oscillation threshold current to the maximum rated current of each laser-light source, and the remaining fraction of the laser-light sources which are not selected above are stopped, so that the optical output power of the combined laser light is equalized with the target value.

### BACKGROUND OF THE INVENTION

1. Field of the Invention

The present invention relates to a method and a system for irradiation with combined laser light, which is generated by combining laser beams emitted from a plurality of laser-light sources.

2. Description of the Related Art

Conventionally, combined-laser-light irradiation systems for recording image information in a recording medium made of a photosensitive material or the like with combined laser light are known, where the combined laser light is generated by combining laser beams emitted from a plurality of laser-light sources. In particular, in some combined-laser-light irradiation systems, as disclosed in Japanese Unexamined Patent Publication No. 2000-190563, a plurality of semiconductor lasers having identical characteristics are used, and the optical output power of the combined laser light is controlled by equally increasing or decreasing the driving currents supplied to the plurality of semiconductor lasers so that the measured value of the optical output power of the combined laser light generated by combining laser beams emitted from the plurality of semiconductor lasers is equalized with a target value of the optical output power. At this time, the range within which the optical output power of the combined laser light is controlled is determined on the basis of the range of the optical output power of each semiconductor laser. That is, the range within which the optical output power of the combined laser light is controlled is the range in which the optical output power of the combined laser light varies when each semiconductor laser is driven with the driving current in the range from the oscillation threshold current to the maximum rated current value.

On the other hand, the recording mediums in which image information can be recorded by irradiation with the above combined laser light have various photosensitivities. In order to record image information in the recording mediums having various photosensitivities, it is necessary to control the optical output power of the combined laser light according to the photosensitivities of the respective recording mediums.

However, if a construction for generating the combined laser light is configured in such a manner that the maximum value of the optical output power of the combined laser light is a great value which is appropriate for a recording medium having a low photosensitivity, in some case, the lower limit of the range within which the optical output power of the combined laser light can be controlled in the system may be greater than another value of the optical output power which is appropriate for a recording medium having a very high photosensitivity. In this case, even when each semiconductor laser is driven with the oscillation threshold current, the optical output power of the combined laser light exceeds the value appropriate for the recording medium having the very high photosensitivity. If a recording medium is irradiated with combined laser light having an inappropriate optical output power, the quality of image information recorded in the recording medium deteriorates.

Further, if each semiconductor laser is driven with the driving current lower than the oscillation threshold current (i.e., each semiconductor laser is driven so as to output light by spontaneous emission) in order to lower the optical output power of the combined laser light, the wavelength range of the combined laser light is broadened, so that the recording medium is irradiated with light having wavelengths out of a predetermined wavelength range. In addition, when the driving current is lower than the oscillation threshold current, the optical output power of the combined laser light rapidly varies with the driving current, and therefore control of the optical output power of the combined laser light is difficult. Consequently, it is not practical to drive the semiconductor lasers with the driving current lower than the oscillation threshold current.

### SUMMARY OF THE INVENTION

The present invention has been developed in view of the above circumstances.

The object of the present invention is to provide a method and a system for irradiation of a recording medium with combined laser light, the optical output power of which can be controlled within an extended range.

In order to accomplish the above object, the first aspect of the present invention is provided. According to the first aspect of the present invention, there is provided a method for irradiating a recording medium with combined laser light generated by combining laser beams emitted from a plurality of laser-light sources each having an oscillation threshold current and a maximum rated current. The method comprises the steps of: (a) selecting a first fraction of the plurality of laser-light sources when a target value of the optical output power of the combined laser light which is determined in correspondence with the photosensitivity of the recording medium is smaller than a predetermined reference value; and (b) driving each of the first fraction of the plurality of laser-light sources with a driving current within a range from the oscillation threshold current to the maximum rated current, and stopping a second fraction of the plurality of laser-light sources which are not selected in step (a), so that the optical output power of the combined laser light is equalized with the target value.

In order to accomplish the aforementioned object, the second aspect of the present invention is provided. According to the second aspect of the present invention, there is provided a system for irradiating a recording medium with combined laser light. The system comprises: a plurality of laser-light sources which emit a plurality of laser beams, and each of which has an oscillation threshold current and a maximum rated current; a combining unit which combines the plurality of laser beams so as to generate the combined laser light; an irradiation unit which irradiates the recording medium with the combined laser light; a target-value reception unit which receives a target value of the optical output power of the combined laser light which is determined in correspondence with the photosensitivity of the recording medium; and an optical-output-power control unit which equalizes the optical output power with the target value with the target value by selecting a first fraction of the plurality of laser-light sources, driving each of the first fraction of the plurality of laser-light sources with a driving current within a range from the oscillation threshold current to the maximum rated current, and stopping a second fraction of the plurality of laser-light sources which are not selected, when the target value of the optical output power of the combined laser light is smaller than a predetermined reference value.

The oscillation threshold current is the minimum driving current necessary for making each laser-light source output light by stimulated emission.

The reference value is predetermined to be the value of optical output power of the combined laser light which is obtained when all of the plurality of laser-light sources are driven with their oscillation threshold currents, or another value which is near to and greater than the value of the optical output power obtained as above.

The stopping of the second fraction of the plurality of laser-light sources means to make the second fraction of the plurality of laser-light sources emit no light. However, even in the case where the second fraction of the plurality of laser-light sources are driven with a driving current below the oscillation threshold current, and light by spontaneous emission can be emitted from the second fraction of the plurality of laser-light sources, it is possible to deem that the second fraction of the plurality of laser-light sources are stopped, as long as the light by spontaneous emission does not affect the irradiation of the recording medium.

The plurality of laser-light sources may be of any type, and for example, semiconductor lasers, solid-state lasers, or gas lasers.

In addition, the plurality of laser-light sources may have identical characteristics. Alternatively, a fraction of the plurality of laser-light sources may have different characteristics from the other of the plurality of laser-light sources.

According to the first and second aspects of the present invention, it is possible to decrease the minimum possible value (lower limit) of the optical output power of the combined laser light without decreasing the maximum possible value (upper limit) of the optical output power of the combined laser light. That is, it is possible to extend the range within which the optical output power of the combined laser light can be controlled.

### DESCRIPTION OF THE DRAWINGS

FIG. 1 is a diagram schematically illustrating a construction of a combined-laser-light irradiation system according to an embodiment of the present invention.

FIG. 2 is a graph indicating an example of a relationship between driving current and optical output power of each semiconductor laser.

FIG. 3 is a graph indicating examples of relationships between driving current and optical output power of combined laser light.

FIG. 4 is a flow diagram indicating a sequence of operations performed when a recording medium is irradiated with the combined laser light.

FIG. 5 is a graph indicating a relationship between the relative driving current and the optical output power of combined laser light.

FIG. 6 is a graph provided for explaining a way of obtaining the relative driving current by linear interpolation on the basis of data obtained from a data table.

### DESCRIPTION OF PREFERRED EMBODIMENTS

An embodiment of the present invention is explained in detail below with reference to drawings.

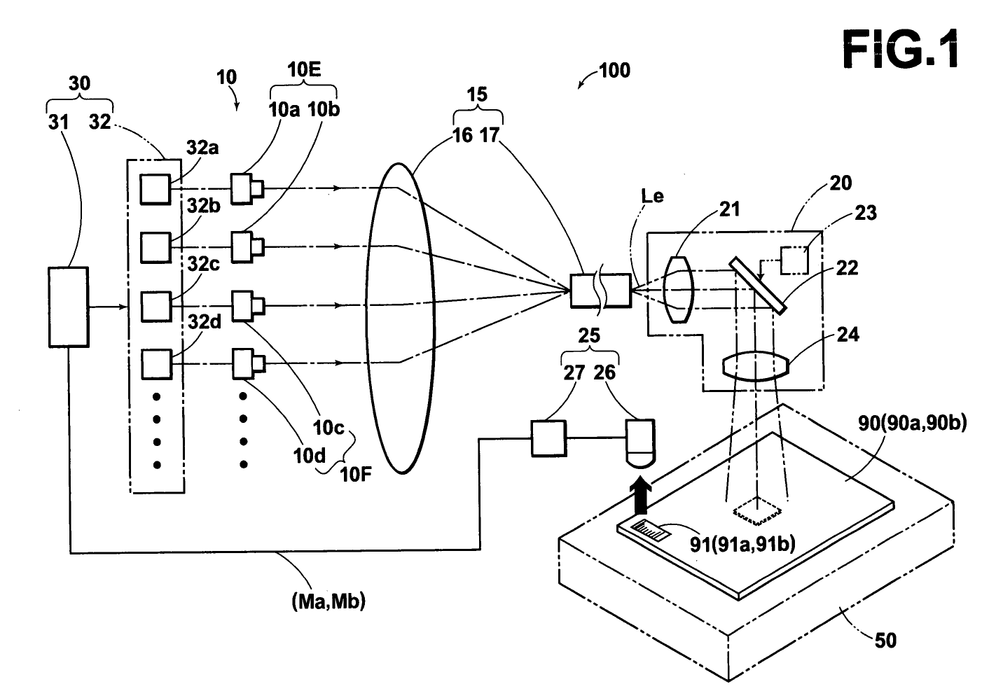

FIG. 1 is a diagram schematically illustrating a construction of a combined-laser-light irradiation system according to an embodiment of the present invention. As illustrated in FIG. 1, the combined-laser-light irradiation system 100 comprises a plurality (k) of semiconductor lasers 10a, 10b, 10c, 10d, . . . (which may be hereinafter referred to as the semiconductor lasers 10), a combining unit 15, and an irradiation unit 20. The combining unit 15 combines laser beams emitted from the plurality of semiconductor lasers 10 so as to generate combined laser light Le. The irradiation unit 20 irradiates a recording medium 90 with the combined laser light Le, where the recording medium 90 is made of a photosensitive material.

The combined-laser-light irradiation system 100 further comprises a target-value receiving unit 25 and an optical-output-power control unit 30. A target value of the optical output power of the combined laser light Le is inputted through the target-value input unit 25. The optical-output-power control unit 30 selects a first fraction 10a, 10b, . . . of the plurality of semiconductor lasers 10 (which may be hereinafter referred to as the semiconductor lasers 10E), drives each of the selected semiconductor lasers 10E with a driving current within a range from the oscillation threshold current to the maximum rated current, and stops a second fraction 10c, 10d, . . . of the plurality of semiconductor lasers 10 (which are not selected, and may be hereinafter referred to as the semiconductor lasers 10F), so that the optical output power of the combined laser light Le is equalized with the target value, when the target value of the optical output power of the combined laser light Le (which is inputted through the target-value receiving unit 25) is smaller than a predetermined reference value.

The combining unit 15 comprises a condensing lens 16 and an optical fiber 17. The condensing lens 16 converges the laser beams emitted from the semiconductor lasers 10 into a point. The laser beams converged by the condensing lens 16 enter the optical fiber 17 and are combined in the optical fiber 17 to generate the combined laser light Le, which is then outputted from the optical fiber 17.

The irradiation unit 20 comprises a collimator lens 21, a DMD (digital micromirror device) 22, a DMD controller 23, and an image-forming lens 24. The collimator lens 21 collimates the combined laser light Le outputted from the optical fiber 17. The DMD 22 reflects the combined laser light Le collimated by the collimator lens 21 so as to spatially modulate the collimated combined laser light Le in accordance with image information (reflection pattern) as explained later. The DMD controller 23 controls the DMD 22. The image-forming lens 24 forms an image of the spatially modulated light on the recording medium 90, which is placed on a carrier table 50 provided in the combined-laser-light irradiation system 100.

The DMD 22 is a spatial light-modulation device in which a plurality of micromirrors are arrayed in columns and rows (e.g., 1,024 columns and 756 rows), where each of plurality of micromirrors corresponds to a pixel, and can be individually controlled to change the orientation of the reflection surface. Therefore, a plurality of portions of laser light injected into the DMD 22 are respectively reflected by the plurality of micromirrors, so that the laser light injected into the DMD 22 is spatially modulated.

The target-value receiving unit 25 comprises a reading unit 26 and a storage unit 27. The reading unit 26 reads a bar code 91 being indicated on the recording medium 90 and representing the target value, and the storage unit 27 stores the target value represented by the bar code 91.

The optical-output-power control unit 30 comprises a laser controller 31 and drivers 32a, 32b, . . . (which may be hereinafter referred to as the drivers 32). The laser controller 31 receives the target value from the storage unit 27 in the target-value receiving unit 25, and selects one or more semiconductor lasers to be driven from among the plurality of semiconductor lasers 10, determines the values of the driving currents of the one or more semiconductor lasers, and stops driving of the other semiconductor lasers. The drivers 32 drives the one or more semiconductor lasers selected by the laser controller 31 with the driving current determined and controlled by the laser controller 31.

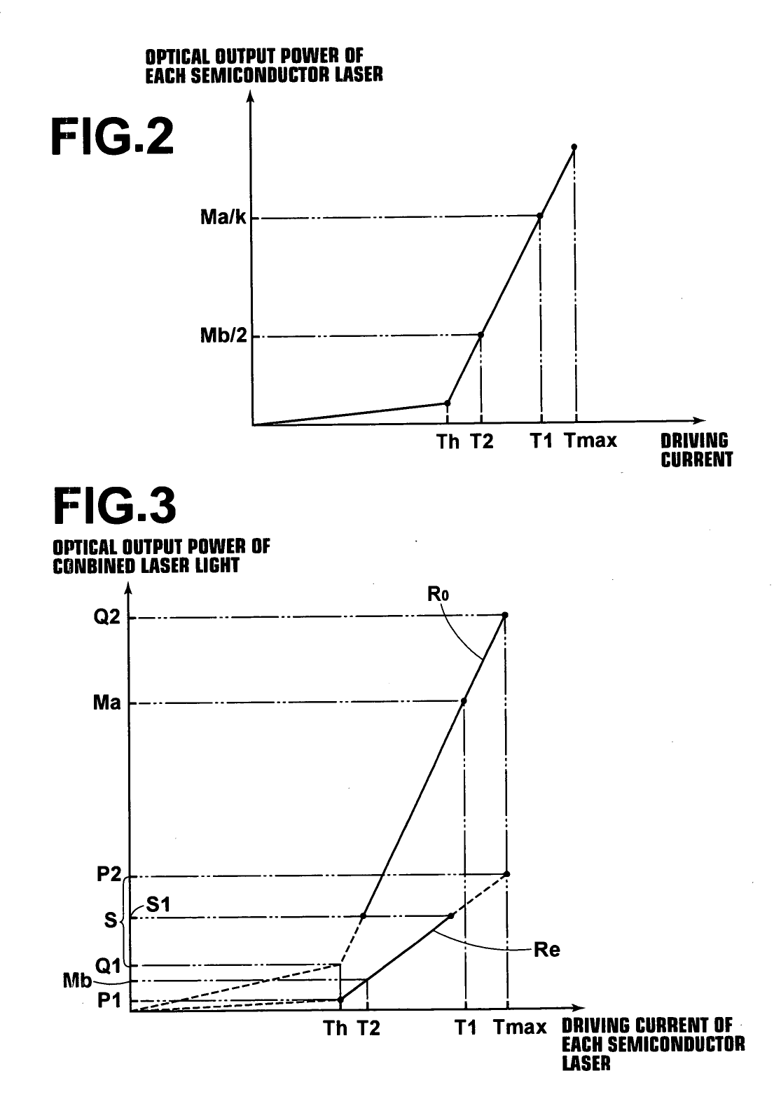

Specifically, the laser controller 31 stores in advance basic data indicating a first relationship between the driving current of each semiconductor laser and optical output power of laser light emitted from each semiconductor laser. An example of the first relationship is indicated in the graph of FIG. 2. In this example, it is assumed that the plurality of semiconductor lasers 10 have identical characteristics, i.e., all the semiconductor lasers 10 have the relationship of FIG. 2. As indicated in FIG. 2, light by spontaneous emission is outputted from each semiconductor laser when the driving current is below the oscillation threshold current Th, and light by stimulated emission is outputted from each semiconductor laser when the driving current is in the range from the oscillation threshold current Th to the maximum rated current Tmax.

In addition, the laser controller 31 stores in advance reference data which is obtained on the basis of the above first relationships between the driving current and the optical output power of each semiconductor laser. The reference data indicates a second relationship between the values of the driving current common to each semiconductor laser and the optical output power of the combined laser light in each of a plurality of cases where all or a fraction of the plurality of semiconductor lasers 10 are selected and driven.

Two examples of the above second relationships (reference data) are indicated in FIG. 3, which is a graph indicating the examples of the second relationships between driving current and optical output power of combined laser light. In FIG. 3, the curve Ro indicates a relationship (output characteristic) in the case where all of the semiconductor lasers 10 are driven, and the curve Re indicates a relationship (output characteristic) in the case where only two (the semiconductor lasers 10a and 10b) of the semiconductor lasers 10 are driven. In addition, light by spontaneous emission is emitted from each semiconductor laser when the driving current I of each semiconductor laser is below the oscillation threshold current Th, and light by stimulated emission is emitted from each semiconductor laser when the driving current I of each semiconductor laser is equal to or greater than the oscillation threshold current Th, and smaller the maximum rated current Tmax. The combined-laser-light irradiation system 100 uses only the light by stimulated emission for recording in the recording medium 90.

The aforementioned reference value is predetermined in the range from the value Q1 to the value P2, which is indicated by S in FIG. 3, and and stored in the laser controller 31. The value Q1 is a value of the optical output power of the combined laser light which is obtained when all of the semiconductor lasers 10 are driven with the oscillation threshold current Th, and the value P2 is a value of the optical output power of the combined laser light which is obtained when only a fraction of the semiconductor lasers 10 (e.g., only the two semiconductor lasers 10E) are driven with the maximum rated current Tmax.

As indicated in FIG. 3, the optical output power of the combined laser light which is obtained when all of the semiconductor lasers 10 are driven with a driving current in the range from the oscillation threshold current Th to the maximum rated current Tmax is in the range from the value Q1 to the value Q2, and the optical output power of the combined laser light which is obtained when only a fraction of the semiconductor lasers 10 (e.g., only the two semiconductor lasers 10E) are driven with a driving current in the range from the oscillation threshold current Th to the maximum rated current Tmax is in the range from the value P1 to the value P2. In particular, when the target value (indicated by S1 in FIG. 3) of the optical output power of the combined laser light Le is smaller than the aforementioned reference value, only the fraction of the semiconductor lasers 10 (e.g., only the two semiconductor lasers 10E) are driven, the other semiconductor lasers 10F are stopped, and the optical output power of the combined laser light is controlled within a range from the value P1 to a value smaller than the reference value S1. On the other hand, when the target value (indicated by S1 in FIG. 3) of the optical output power of the combined laser light Le is equal to or greater than the reference value, all of the semiconductor lasers 10 are driven, and the optical output power of the combined laser light is controlled within the range from the reference value S to the value Q2. Thus, it is possible to realize the optical output power of the combined laser light which is below the range of the optical output power which is obtained when all of the semiconductor lasers 10 are driven.

Hereinbelow, operations performed by the combined-laser-light irradiation system 100 are explained.

First, operations for recording image information in a recording medium 90a having a low photosensitivity are explained below.

When the recording medium 90a is placed on the carrier table 50 in the combined-laser-light irradiation system 100, the reading unit 26 reads the bar code 91a indicated on the recording medium 90a, and a target value Ma of the optical output power represented by the bar code 91a is stored in the storage unit 27. Thereafter, the laser controller 31 in the optical-output-power control unit 30 reads out the target value Ma from the storage unit 27, and compares the target value Ma with the reference value S1. In this case, the target value Ma is equal to or greater than the reference value S1 (Ma≧S1). Therefore, the laser controller 31 controls the drivers 32 to drive each of the semiconductor lasers 10 with a driving current in the range from the oscillation threshold current to the maximum rated current, and equalize the optical output power of the combined laser light Le with the target value Ma.

In order to drive each of the semiconductor lasers 10 with a driving current in the range from the oscillation threshold current to the maximum rated current, and equalize the optical output power of the combined laser light Le with the target value Ma, the laser controller 31 refers to portions of the reference data (output characteristic) corresponding to the curve Ro in FIG. 3, determines a driving current T1 for each semiconductor laser corresponding to the target value Ma of the optical output power, and controls the respective drivers 32a, 32b, . . . to drive the semiconductor lasers 10a, 10b, . . . with the driving current T1. Thus, each of the semiconductor lasers 10 outputs a laser beam having an optical output power of Ma/k (i.e., the target value Ma divided by the number k of the semiconductor lasers 10), so that the optical output power of the combined laser light Le generated by the combining unit 15 becomes Ma.

The combined laser light Le obtained as above enters the irradiation unit 20, propagates through the collimator lens 21, is spatially modulated by the DMD 22, and is then applied through the image-forming lens 24 to the recording medium 90a, which cam be moved with the carrier table 50. Thus, image information corresponding to the spatial modulation by the DMD 22 is recorded in the recording medium 90a.

Next, operations for recording image information in a recording medium 90b having a high photosensitivity are explained below.

When the recording medium 90b is placed on the carrier table 50 in the combined-laser-light irradiation system 100, the reading unit 26 reads the bar code 91b indicated on the recording medium 90b, and a target value Mb of the optical output power represented by the bar code 91b is stored in the storage unit 27. Thereafter, the laser controller 31 in the optical-output-power control unit 30 reads out the target value Mb from the storage unit 27, and compares the target value Mb with the reference value S1. In this case, the target value Mb is smaller than the reference value S1 (Mb<S1). Therefore, the laser controller 31 selects only a fraction of the semiconductor lasers 10 (e.g., two semiconductor lasers 10E), and controls a fraction of the drivers 32 (e.g., two drivers 32a and 32b) to drive the selected fraction of the semiconductor lasers 10 (e.g., two semiconductor lasers 10E) with a driving current in the range from the oscillation threshold current to the maximum rated current, and the other of the drivers 32 to stop the other semiconductor lasers 10F, so that the optical output power of the combined laser light Le is equalized with the target value Mb.

In order to drive each of the selected fraction of the semiconductor lasers 10 (e.g., the two semiconductor lasers 10E) with a driving current in the range from the oscillation threshold current to the maximum rated current, and equalize the optical output power of the combined laser light Le with the target value Mb, the laser controller 31 refers to portions of the reference data (output characteristic) corresponding to the curve Re in FIG. 3, determines a driving current T2 for each semiconductor laser in the fraction of the semiconductor lasers 10 (e.g., the two semiconductor lasers 10E) corresponding to the target value Mb of the optical output power, and controls the fraction of the drivers 32 (e.g., the two drivers 32a and 32b) to drive the fraction of the semiconductor lasers 10 (e.g., the two semiconductor lasers 10E) with the driving current T2. Thus, for example, when the number of the selected semiconductor lasers is two, each of the two semiconductor lasers 10E outputs a laser beam having an optical output power of Mb/2 (i.e., the target value Mb divided by two), so that the optical output power of the combined laser light Le generated by the combining unit 15 is equalized with the target value Mb.

When the combined laser light is generated as explained above, it is possible to record image information in recording mediums having photosensitivities in a wider range, with appropriate optical output power. That is, it is possible to extend the range in which the optical output power of the combined laser light can be controlled.

Although each semiconductor laser has an identical characteristic, and an identical relationship between the driving current and the optical output power of laser light in the above example, alternatively, the semiconductor lasers may have different characteristics and different relationships between the driving current and the optical output power of laser light. When the combined laser light is controlled in the manner explained below, it is possible to control the optical output power of the combined laser light regardless of whether or not the characteristics of the semiconductor lasers are identical.

Even when the characteristics of the semiconductor lasers are not identical, and the oscillation threshold currents and the maximum rated currents of the semiconductor lasers are different, the optical output power of the combined laser light can be controlled more easily by controlling the relative driving current, which is defined by the formula,
Relative Driving Current=(I−Ith)/(Imax−Ith),
where I is the driving current, Ith is the oscillation threshold current, and the Imax is the maximum rated current. The maximum rated current is the driving current which makes each semiconductor laser output a maximum rated amount of light.

The above formula indicates that the relative driving current is zero (0%) when the actual value of the driving current is equal to the oscillation threshold current, and is one (100%) when the actual value of the driving current is equal to the maximum rated current.

Hereinbelow, operations for controlling the optical output power of the combined laser light by controlling the relative driving current are explained in detail.

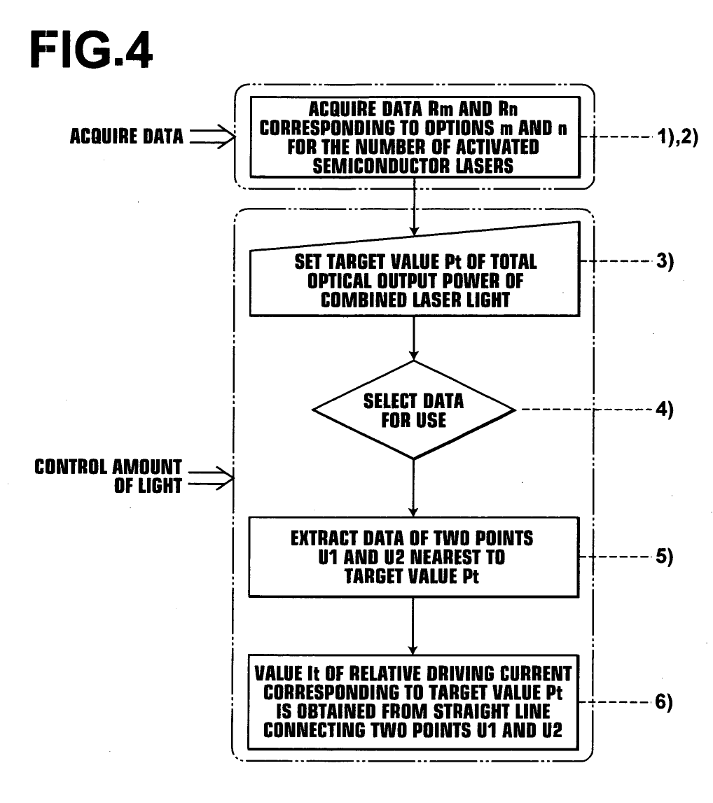

FIG. 4 is a flow diagram indicating a sequence of operations for controlling the optical output power of the combined laser light by controlling the relative driving current. In this example, the semiconductor lasers are controlled in such a manner that the relative driving currents of all the semiconductor lasers are identical. In FIG. 4, the optical output power of the combined laser light is also referred to the total optical output power.

In step 1, for example, two options for the number of the activated (driven) semiconductor lasers (light-emitting elements) are determined. Specifically, the number m of the activated (driven) semiconductor lasers (light-emitting elements) is determined on the basis of an appropriate exposure (amount of light) for a recording medium having a low photosensitivity, and the number n of the activated (driven) semiconductor lasers (light-emitting elements) is determined on the basis of an appropriate exposure (amount of light) for a recording medium having a high photosensitivity, where m>n.

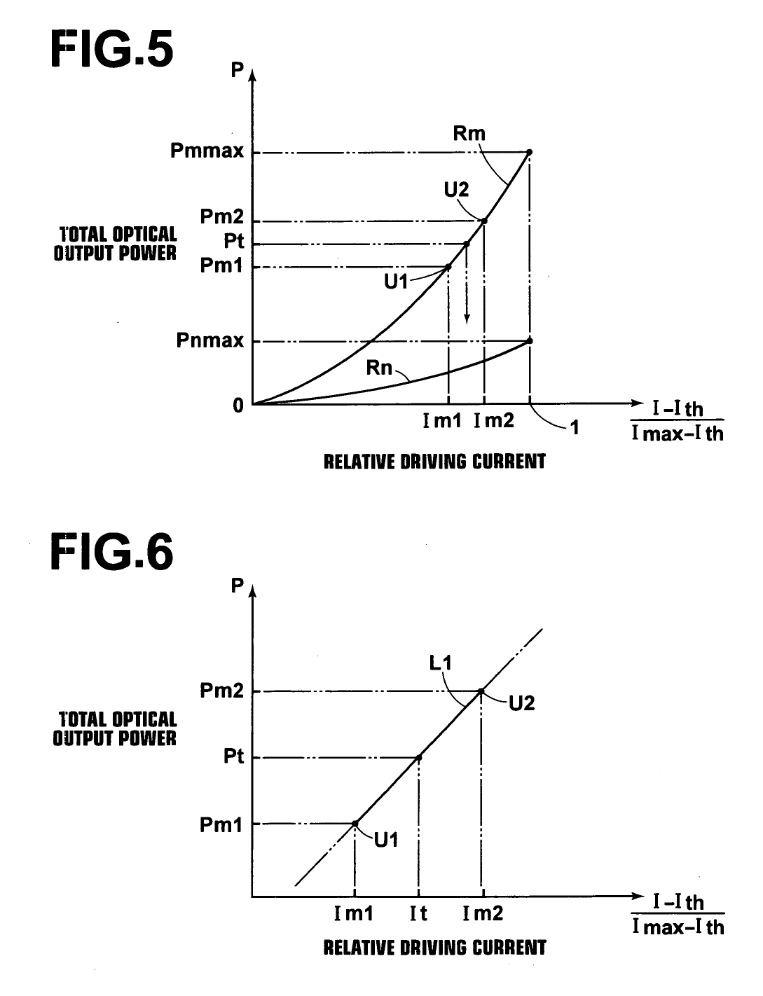

In step 2, data indicating a relationship between the relative driving current and the total optical output power P for each of the numbers m and n are obtained and stored in the form of a data table. FIG. 5 is a graph indicating an example of the above relationship between the relative driving current and the optical output power of the combined laser light P. In FIG. 5, the curve Rm indicates a relationship between the total optical output power P and the relative driving current of each of activated semiconductor lasers in the case where the number of the activated semiconductor lasers is m, and the curve Rn indicates a relationship between the total optical output power P and the relative driving current of each of activated semiconductor lasers in the case where the number of the activated semiconductor lasers is n. In FIG. 5, the total optical output power which is obtained when the relative driving current is one (100%) is the maximum value Pm max in the case where the number of the activated semiconductor lasers is m, and the maximum value Pn max in the case where the number of the activated semiconductor lasers is n.

In step 3, a target value Pt of the optical output power of the combined laser light is set in correspondence with the photosensitivity of the recording medium to which the combined laser light is to be applied.

In step 4, one of the numbers m and n is selected on the basis of the above target value Pt, and the data corresponding to the selected number and indicating the relationship between the relative driving current and the total optical output power P as illustrated in FIG. 5 is referred to. That is, the data representing the curve Rm (corresponding to the number m) are referred to when the target value Pt is equal to or greater than the maximum value Pn max, and the data representing the curve Rn (corresponding to the number n) are referred to when the target value Pt is smaller than the maximum value Pn max. In this case, the maximum value Pn max is the aforementioned reference value.

In step 5, the data representing the curve Rm is referred to, since, in this example, it is assumed that the the target value Pt is equal to or greater than the maximum value Pn max. Then, data items of the two points U1 (Pm1, Im1) and U2 (Pm2, Im2) on the curve Rm which are nearest to the target value Pt and on both sides of the target value Pt are extracted from the data table.

FIG. 6 is a magnified portion of the graph of FIG. 5, which is provided for explaining a way of obtaining the relative driving current by linear interpolation on the basis of data obtained from the data table. In step 6, as illustrated in FIG. 6, a straight line L1 connecting the above two points U1 (Pm1, Im1) and U2 (Pm2, Im2) is obtained, and then the value It of the relative driving current corresponding to the target value Pt is obtained.

Although, in the above example, two options for the number of the activated (driven) semiconductor lasers (light-emitting elements) are initially determined in step 1, it is possible to initially determine more than two options for the number of the activated (driven) semiconductor lasers (light-emitting elements).

Further, the data indicating a relationship between the relative driving current and the total optical output power P for each of the numbers m and n may be stored in the form of an approximate straight line instead of a data table.

In addition, all of the contents of the Japanese patent application No. 2004-183571 are incorporated into this specification by reference.

What is claimed is:

1. A method for irradiating a recording medium having a photosensitivity, with combined laser light which has an optical output power and is generated by combining laser beams emitted from a plurality of laser-light sources each having an oscillation threshold current and a maximum rated current, comprising the steps of:
(a) selecting a first fraction of said plurality of laser-light sources when a target value of the optical output power of the combined laser light which is determined in correspondence with the photosensitivity of said recording medium is smaller than a predetermined reference value; and
(b) driving each of the first fraction of the plurality of laser-light sources with a driving current within a range from the oscillation threshold current to the maximum rated current, and stopping a second fraction of the plurality of laser-light sources which are not selected in step (a), so that the optical output power of the combined laser light is equalized with the target value.

2. A system for irradiating a recording medium having a photosensitivity with combined laser light having an optical output power, comprising:
a plurality of laser-light sources which emit a plurality of laser beams, and each of which has an oscillation threshold current and a maximum rated current;
a combining unit which combines the plurality of laser beams so as to generate said combined laser light;
an irradiation unit which irradiates said recording medium with said combined laser light;
a target-value reception unit which receives a target value of the optical output power of the combined laser light which is determined in correspondence with the photosensitivity of the recording medium; and
an optical-output-power control unit which equalizes the optical output power with the target value with the target value by selecting a first fraction of said plurality of laser-light sources, driving each of the first fraction of the plurality of laser-light sources with a driving current within a range from the oscillation threshold current to the maximum rated current, and stopping a second fraction of the plurality of laser-light sources which are not selected, when the target value of the optical output power of the combined laser light is smaller than a predetermined reference value.

3. A system according to claim 2, wherein said plurality of laser-light sources are semiconductor lasers.

4. A system according to claim 2, wherein a third fraction of said plurality of laser-light sources have a first characteristic which is different from a second characteristic which a fourth fraction of the plurality of laser-light sources have.

5. A system according to claim 3, wherein a third fraction of said plurality of laser-light sources have a first characteristic which is different from a second characteristic which a fourth fraction of the plurality of laser-light sources have.

6. A system according to claim 2, wherein said plurality of laser-light sources have identical characteristics.

7. A system according to claim 3, wherein said plurality of laser-light sources have identical characteristics.
